(19) United States
(12) Patent Application Publication
(10) Pub. No.: US 2024/0054411 A1
(43) Pub. Date: Feb. 15, 2024

(54) ITINERARY MATCHING SYSTEM, ITINERARY MATCHING METHOD, AND STORAGE MEDIUM

(71) Applicant: TOYOTA JIDOSHA KABUSHIKI KAISHA, Toyota-shi (JP)

(72) Inventors: Taizo MASUDA, Yokohama-shi (JP); Kiyoto SASAKI, Susono-shi (JP); Daisuke KAKUMA, Toyota-shi (JP); Hiroyoshi MASUI, Susono-shi (JP); Akihiro YAMAGUCHI, Toyota-shi (JP); Sokfan YEE, Toyota-shi (JP); Yuki NISHIKAWA, Numazu-shi (JP)

(73) Assignee: TOYOTA JIDOSHA KABUSHIKI KAISHA, Toyota-shi (JP)

(21) Appl. No.: 18/330,835

(22) Filed: Jun. 7, 2023

(30) Foreign Application Priority Data
Aug. 10, 2022 (JP) 2022-128050

(51) Int. Cl. G06Q 10/02

(52) U.S. Cl. CPC G06Q 10/025

(57) ABSTRACT

An itinerary matching system according to the present disclosure includes a process of receiving registration of an itinerary, a process of extracting two registered itineraries from among a plurality of registered itineraries that have been registered and calculating a degree of matching between the two registered itineraries that have been extracted, a process of generating, upon receiving that the degree of matching exceeds a predetermined threshold value, a merged itinerary in which the two registered itineraries are merged, and a process of setting, upon receiving acceptance from a participant of each of the two registered itineraries, the participant of each of the two registered itineraries as a participant of the merged itinerary.

### CROSS-REFERENCE TO RELATED APPLICATION

This application claims priority to Japanese Patent Application No. 2022-128050 filed on Aug. 10, 2022, incorporated herein by reference in its entirety.

### BACKGROUND

### 1. Technical Field

The present disclosure relates to a technique for providing matching of participants of an itinerary.

### 2. Description of Related Art

Japanese Unexamined Patent Application Publication No. 2016-194854 (JP 2016-194854 A) discloses a ridesharing support system in which a user who is a driver of a vehicle recruits other passengers for a certain itinerary, a user who wishes to ride together for the itinerary applies for the itinerary, and rideshare matching between the user who is the driver and the user who wishes to ride together is performed.

### SUMMARY

The ridesharing support system according to JP 2016-194854 A provides rideshare matching when a user recruits other passengers for a planned itinerary in which a vehicle is used to move from a certain starting point to a certain destination. However, it is assumed that the user wishes to recruit participants of a more general itinerary in which the means of transportation is not limited to the vehicle and a route includes a plurality of destinations. Thus, there is a need for a system that provides matching of participants of a general itinerary. On the other hand, in such a system, since there are many variations of target itineraries, the feasibility of matching becomes an issue.

In view of the above issue, one object of the present disclosure is to provide a technique capable of providing matching of participants of a general itinerary and ensuring the feasibility of matching.

A first aspect of the present disclosure relates to an itinerary matching system for providing matching of participants of an itinerary.

The itinerary matching system according to the first aspect includes one or more processors, and the one or more processors are characterized by being configured to execute: a first process of receiving registration of the itinerary; a second process of extracting two registered itineraries from among a plurality of registered itineraries that have been registered and calculating a degree of matching between the two registered itineraries that have been extracted; a third process of generating, upon receiving that the degree of matching exceeds a predetermined threshold value, a merged itinerary in which the two registered itineraries are merged; and a fourth process of setting, upon receiving acceptance from a participant of each of the two registered itineraries, the participant of each of the two registered itineraries as a participant of the merged itinerary.

A second aspect relates to an itinerary matching method for providing matching of participants of an itinerary by a computer.

The itinerary matching method according to the second aspect is characterized by including: receiving registration of the itinerary;
extracting two registered itineraries from among a plurality of registered itineraries that have been registered and calculating a degree of matching between the two registered itineraries that have been extracted; generating, upon receiving that the degree of matching exceeds a predetermined threshold value, a merged itinerary in which the two registered itineraries are merged; and setting, upon receiving acceptance from a participant of each of the two registered itineraries, the participant of each of the two registered itineraries as a participant of the merged itinerary.

A third aspect relates to a storage medium storing an itinerary matching program that causes a computer to execute a process of providing matching of participants of an itinerary.

The itinerary matching program according to the third aspect is characterized by being configured to cause the computer to execute: a first process of receiving registration of the itinerary; a second process of extracting two registered itineraries from among a plurality of registered itineraries that have been registered and calculating a degree of matching between the two registered itineraries that have been extracted; a third process of generating, upon receiving that the degree of matching exceeds a predetermined threshold value, a merged itinerary in which the two registered itineraries are merged; and a fourth process of setting, upon receiving acceptance from a participant of each of the two registered itineraries, the participant of each of the two registered itineraries as a participant of the merged itinerary.

According to the present disclosure, a function for matching the participants of the registered itineraries is provided. Here, each of the registered itineraries may be a general itinerary in which the means of transportation are not limited and the route includes a plurality of destinations. In particular, according to the present embodiment, the degree of matching is calculated for two registered itineraries extracted from the registered itineraries, and the merged itinerary obtained by merging two registered itineraries in which the degree of matching exceeds the predetermined threshold value is generated. Then, upon receiving the acceptance from the participants of each of the two registered itineraries, the participants of each of the two registered itineraries are set as the participants of the merged itinerary.

Thereby, it is possible to reduce the variations of the registered itineraries, and to reduce the annoyance to the user who intends to apply for participation of one of the registered itineraries. As a result, the feasibility of matching can be ensured. In addition, the feasibility of matching can be improved in that the participants of each of the two registered itineraries in which the degree of matching exceeds the predetermined threshold value can be given an opportunity to match each other.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a conceptual diagram for illustrating an overview of an itinerary matching system according to a present embodiment;

FIG. 1B is a conceptual diagram for illustrating an overview of the itinerary matching system according to the present embodiment;

FIG. 2 is a conceptual diagram showing an example of a registered itinerary;

FIG. 3 is a conceptual diagram showing an example of a list of a registered itinerary;

FIG. 4 is a conceptual diagram for illustrating an example of a degree of matching calculated for two registered itineraries;

FIG. 5 is a conceptual diagram showing an example of a merged itinerary generated for the two registered itineraries shown in FIG. 4;

FIG. 6 is a block diagram showing a preferable example of a configuration of a server according to the present embodiment; and

FIG. 7 is a flowchart showing a process executed by the server according to the present embodiment.

### DETAILED DESCRIPTION OF EMBODIMENTS

1. Itinerary Matching System

An overview of an itinerary matching system according to a present embodiment will be described below with reference to the drawings.

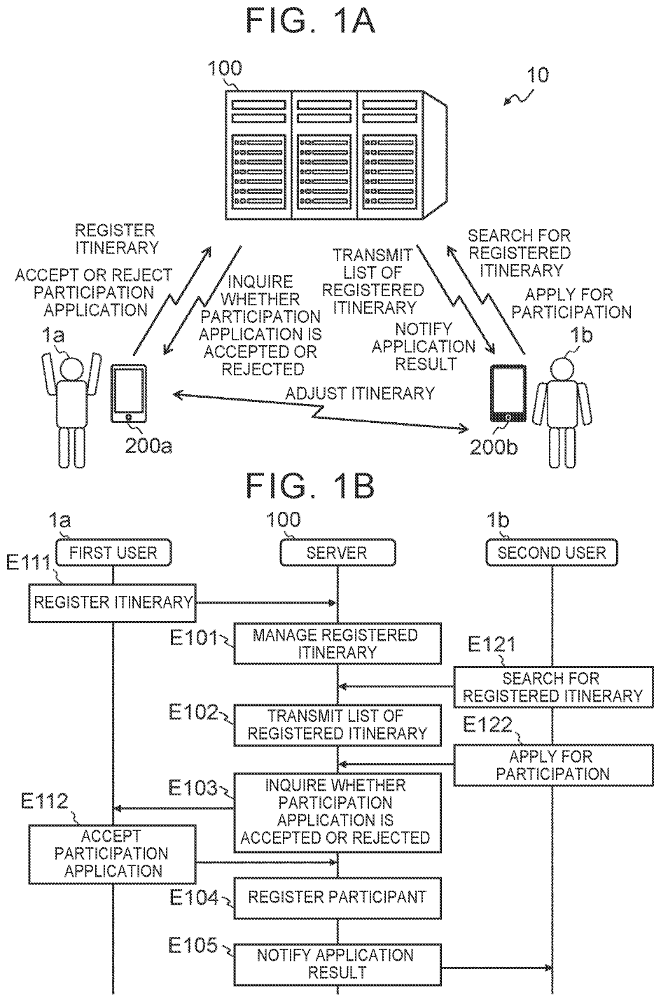

The itinerary matching system according to the present embodiment provides a function of matching of participants of an itinerary (hereinafter also referred to as an “itinerary matching function”). FIGS. 1A and 1B are each a conceptual diagram for illustrating an overview of an itinerary matching system 10 according to the present embodiment. FIG. 1A shows a configuration, and FIG. 1B shows a typical process for the itinerary matching function.

In FIGS. 1A and 1B, the process for the itinerary matching function is executed by a server 100. The server 100 is configured to be able to communicate with a user terminal. That is, a user uses the itinerary matching function by operating the user terminal. Typically, the server 100 is a computer accessible via the Internet, and the user terminal is a mobile terminal (for example, a smartphone) that is connected to the Internet. In particular, the user terminal may be configured such that the itinerary matching function can be used on a predetermined application.

First, the server 100 receives registration of an itinerary from a user who recruits participants of the itinerary. FIGS. 1A and 1B each show a first user 1a who recruits participants of the itinerary, and a user terminal 200a operated by the first user 1a. Then, the first user 1a registers the itinerary by operating the user terminal 200a (E111).

The server 100 manages the itinerary for which the registration has been received (hereinafter also referred to as a “registered itinerary”) (E101). For example, the server 100 creates a database of a plurality of registered itineraries and records them in a storage device. Here, the registered itinerary includes at least information on a route from a starting point to one or more destinations. The registered itinerary may include a specific date and time, activities (eating, shopping, resting, etc.), and designation of the means of transportation, travel routes, and the like. The registered itinerary may also include application conditions (age, gender, etc.) of the participants.

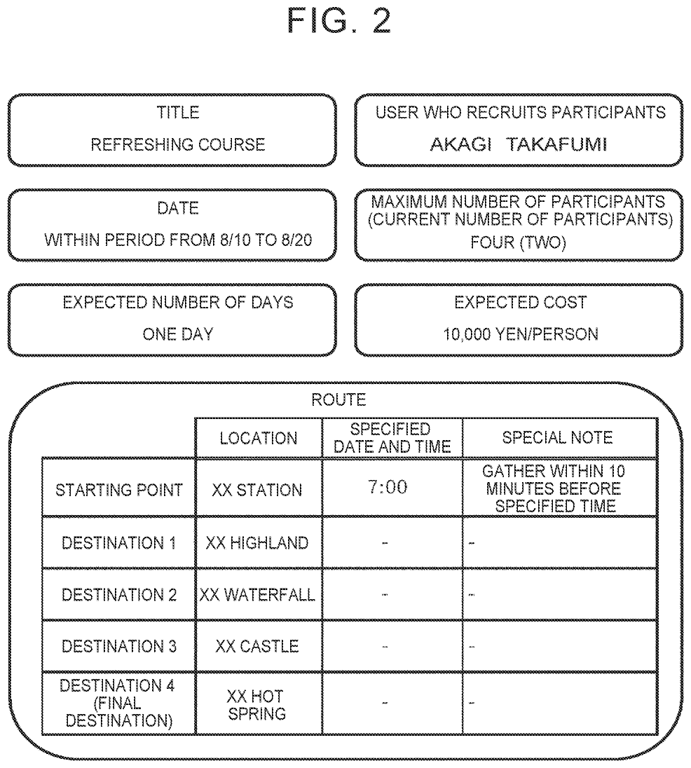

FIG. 2 shows an example of the registered itinerary. In the example of the registered itinerary shown in FIG. 2, in addition to the information on the route from the starting point to the one or more destinations, information on a title, a user who recruits participants, date, the maximum number of participants, the estimated number of days, and an estimated cost are included. In addition, the information on the route indicates a specified date and time and a special note for the starting point. However, the registered itinerary may be configured such that the title, the user who recruits participants, the date, the maximum number of participants, the estimated number of days, the estimated cost, the specified date and time, and the special note are not decided by selection of the first user 1a.

As described above, the registered itinerary may include at least the information on the route from the starting point to the one or more destinations, and may not include designation of the specific date and time, etc. That is, the first user 1a can recruit participants by registering an itinerary in which a place to go is decided but a detailed schedule is not decided. Further, the registered itinerary may be configured to be able to be changed after registering the itinerary. For example, the registered itinerary may be configured such that the first user 1a can add the specified date and time after registering the itinerary. Of course, the first user 1a can also register an itinerary for which a detailed schedule has been decided from the beginning. For example, in a case of the registered itinerary shown in FIG. 2, the first user 1a may register the itinerary by inputting the specified date and time and the special note for each of the starting point and the one or more destinations. The registered itinerary shown in FIG. 2 is an example, and a suitable format for the registered itinerary may be adopted according to an environment to which the itinerary matching system 10 is applied.

FIGS. 1A and 1B are referenced again. Next, the server 100 receives application of participants (participation application) of each of the registered itineraries. FIGS. 1A and 1B each show a second user 1b who is considering to participate in one of the registered itineraries managed by the server 100, and a user terminal 200b operated by the second user 1b.

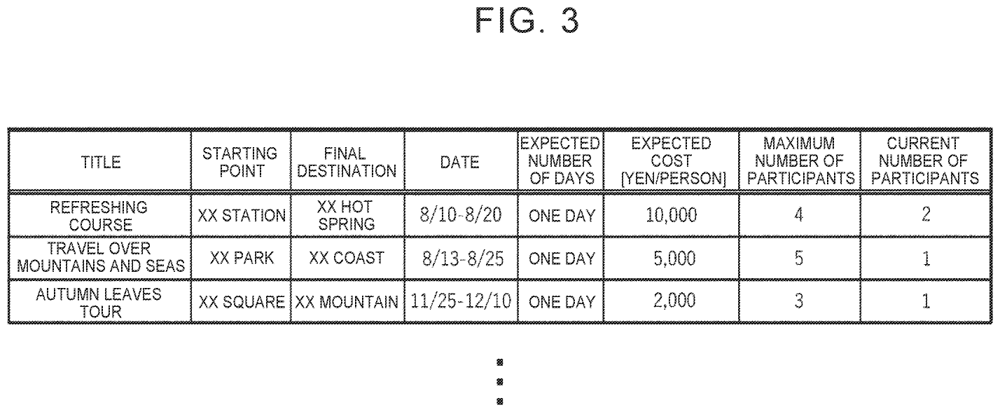

The second user 1b first searches for the registered itinerary by operating the user terminal 200b (E121). In response to the search for the registered itinerary, the server 100 transmits to the user terminal 200b a list of the registered itineraries for the registered itineraries managed by the server 100 (E102). The user terminal 200b notifies the second user 1b of the received registered itinerary list. For example, the user terminal 200b displays the registered itinerary list. FIG. 3 shows an example of display of the registered itinerary list. FIG. 3 shows a state in which information for each item is displayed in a list for the registered itineraries. Further, the user terminal 200b may be configured to display details of a selected registered itinerary when the second user 1b selects one of the registered itineraries displayed in the list. For example, the user terminal 200b displays the selected registered itinerary as shown in FIG. 2.

Next, when there is a registered itinerary in which the second user 1b wishes to participate in the registered itinerary list, the second user 1b applies for participation by operating the user terminal 200b (E122). For example, the second user 1b applies for participation by selecting a participation application button displayed for each of the registered itineraries on the user terminal 200b. Upon receiving the participation application, the server 100 inquires whether the participation application is accepted or rejected to the participant of the target registered itinerary (E103). For example, when the second user 1b applies for participation in the registered itinerary of the first user 1a, the server 100 notifies the user terminal 200a that the participation application has been received, and the user terminal 200a receives acceptance or rejection of the participation application from the first user 1a.

Then, upon receiving that the participant of the target registered itinerary accepts the participation application (E112), the server 100 registers the second user 1b as the participant of the target registered itinerary (E104), and notifies the second user 1b of the application result (E105). On the other hand, when the participant of the target registered itinerary rejects the participation application, the server 100 notifies the second user 1b of the application result without registering the second user 1b as the participant.

Here, when there is a plurality of participants of the target registered itinerary, the server 100 may be configured to inquire whether the participation application is accepted or rejected to all the participants of the target registered itinerary or only to some of the participants of the target registered itinerary. For example, the server 100 may be configured to inquire whether the participation application is accepted or rejected only to the first user 1a who has registered the registered itinerary. In this case, the server 100 registers the second user 1b as the participant upon receiving the acceptance of the participation application from the first user 1a.

As described above, matching of the participants of the itinerary is performed. After the matching is performed, the participants of the itinerary can communicate with each other and adjust the itinerary, thereby determining the specific date and time and carrying out the itinerary. For this reason, the server 100 may be configured to provide the means of communication between the matched participants. For example, the server 100 may be configured to provide a chat function or a call function between the matched participants. Alternatively, the server 100 may be configured to notify the participants of the itinerary of the contact information when the matching is performed.

The participants of the itinerary can also adjust the itinerary by updating the registered itinerary managed by the server 100. For example, in a case of the registered itinerary shown in FIG. 2, after the matching is performed, the participants of the itinerary can adjust the itinerary by adding the specified date and time and the special note. Here, the server 100 may be configured to require the acceptance from all the participants of the itinerary for updating the registered itinerary, or may be configured to require the acceptance from only some of the participants of the itinerary. Alternatively, the server 100 may be configured such that only a representative of the itinerary can update the registered itinerary. For example, the server 100 may be configured such that only the first user 1a who has registered the registered itinerary can update the registered itinerary.

As described above, the itinerary matching system 10 provides the itinerary matching function. In particular, the user can use the itinerary matching function for a general itinerary in which the means of transportation are not limited and the route includes a plurality of destinations. Such an itinerary matching function not only improves convenience for the user when the user recruits the participants of the itinerary, but also has advantages that travel expenses are saved between the participants of the itinerary. For example, the travel expenses can be saved by sharing the means of transportation.

By the way, in the itinerary matching system 10 according to the present embodiment, it is assumed that the registered itineraries include many variations due to differences in the locations of the one or more destinations, the order of passing through the one or more destinations, and the like. However, when the variations of the registered itineraries become excessive, this frequently causes annoyance to the user who searches for the registered itineraries, resulting in a deterioration in the usability of the itinerary matching system 10. As a result, the feasibility of matching is lowered.

In particular, among the registered itineraries, there may be two registered itineraries of which variations are slightly different and that match each other in many respects. Examples thereof include the two registered itineraries in which the starting point and the final destination are different from each other but the routes for the one or more destinations excluding the final destination are the same, and the two registered itineraries in which the locations of the one or more destinations are the same but the order of passing through the one or more destinations excluding the final destination is different from each other. Such two registered itineraries frequently cause annoyance to the user who searches for the registered itineraries.

On the other hand, in such two registered itineraries, participants in one registered itinerary may consider to participate in the other registered itinerary. That is, two such registered itineraries may be able to be merged. When the two registered itineraries can be merged, it is possible to reduce the variations of the registered itineraries, and to reduce the annoyance to the user who searches for the registered itineraries. As a result, the feasibility of matching can be ensured. In addition, the feasibility of matching can be improved in that the participants of each of the two registered itineraries can be given an opportunity to match each other.

Therefore, the itinerary matching system 10 according to the present embodiment further includes, as the itinerary matching function, calculating a degree of matching indicating the degree of matching between two registered itineraries extracted from the registered itineraries, and generating a merged itinerary obtained by merging two registered itineraries in which the degree of matching exceeds a predetermined threshold value.

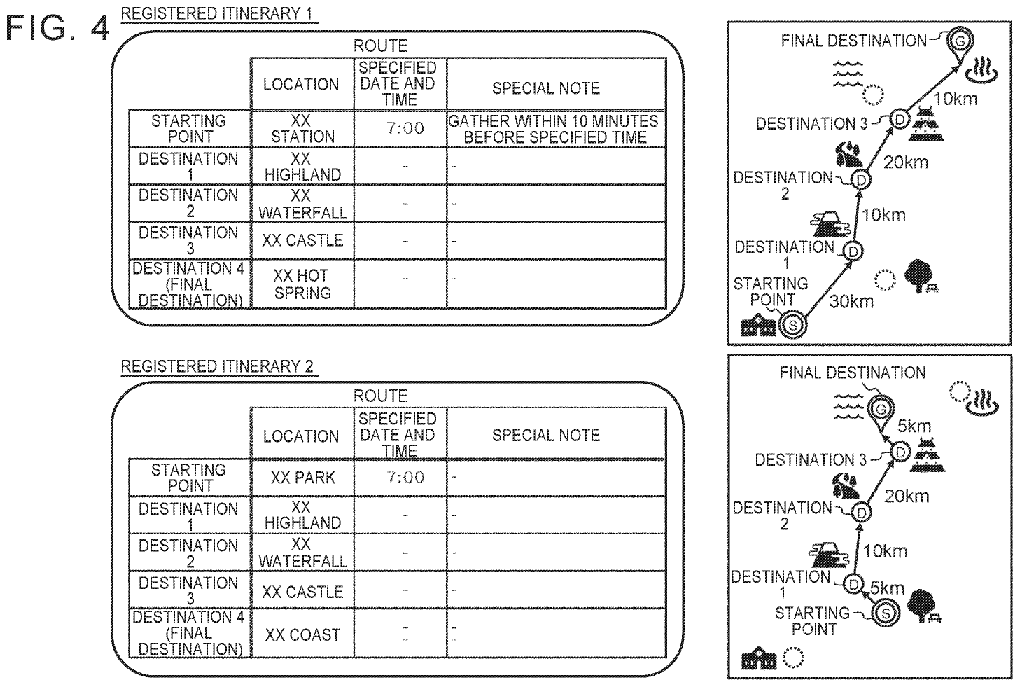

Here, for the degree of matching, for example, the length of overlapping routes in the two registered itineraries can be set as an index. With reference to FIG. 4, an example of calculating the degree of matching when the length of the overlapping routes in the two registered itineraries is used as an index will be described.

FIG. 4 shows a conceptual diagram showing a route and the length of the route for each of two registered itineraries, registered itinerary 1 and registered itinerary 2. In the two registered itineraries shown in FIG. 4, a route from destination 1 to destination 3 in registered itinerary 1 and a route from destination 1 to destination 3 in registered itinerary 2 overlap with each other

At this time, the degree of matching can be calculated as a value obtained by dividing the length of the overlapping routes by the length of the route in the registered itinerary in which the length of the route is shorter among the two registered itineraries. In the two registered itineraries shown in FIG. 4, the length of the overlapping routes is 30 km, the length of the route in registered itinerary 1 is 70 km, and the length of the route in registered itinerary 2 is 40 km. Therefore, the degree of matching is 0.75 obtained by dividing 30 by 40 (30/40=0.75). The degree of matching calculated as described above can be considered to give the reproduction ratio of the route in the other registered itinerary by one registered itinerary in which the length of the route is longer. For example, in the example shown in FIG. 4, it can be considered that 75% of registered itinerary 2 is reproduced by registered itinerary 1.

Then, the server 100 generates the merged itinerary when the degree of matching calculated as described above exceeds the predetermined threshold value. For example, when the predetermined threshold value is 0.7 (70%), the server 100 generates the merged itinerary for the two registered itineraries shown in FIG. 4. The predetermined threshold value may be suitably determined according to an environment to which the itinerary matching system 10 according to the present embodiment is applied. Alternatively, the predetermined threshold value may be configured to be able to be set by the user.

The merged itinerary can be generated by a method according to the degree of matching to be calculated. For example, when the degree of matching that gives the reproduction ratio is calculated as described above, a route passing through the starting points and the one or more destinations in both of the two registered itineraries can be a route in the merged itinerary.

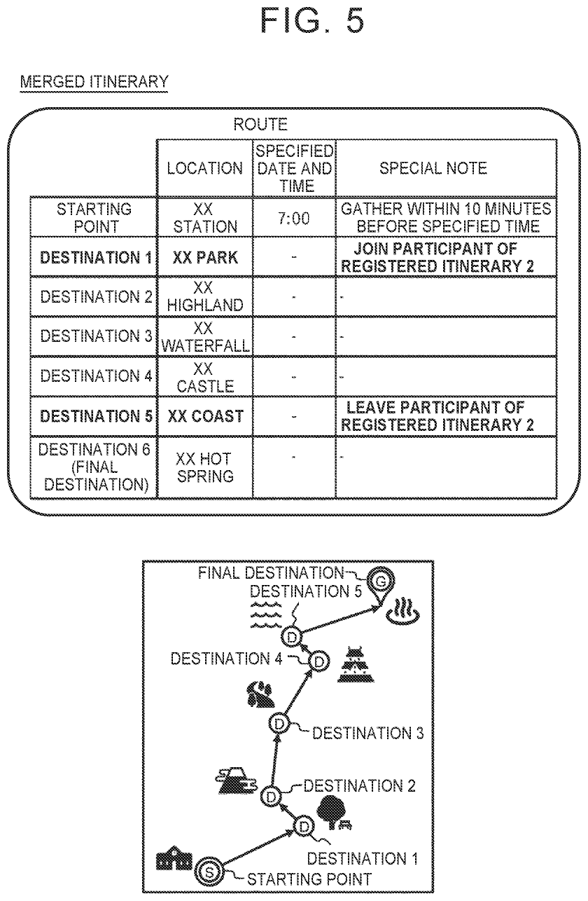

FIG. 5 shows an example of the merged itinerary generated for the two registered itineraries shown in FIG. 4. The route in the merged itinerary shown in FIG. 5 passes through the starting points and the one or more destinations in both of registered itinerary 1 and registered itinerary 2 shown in FIG. 4. In particular, the route in the merged itinerary may be generated such that the route in the registered itinerary in which the length of the route is shorter among the two registered itineraries (hereinafter also referred to as a “child itinerary”) is added to the route in the registered itinerary in which the length of the route is longer among the two registered itineraries (hereinafter also referred to as a “parent itinerary”) such that the route in the parent itinerary passes through the route in the child itinerary. For example, the route in the merged itinerary shown in FIG. 5 is generated such that the route in registered itinerary 2 that is the child itinerary is added to the route in registered itinerary 1 that is the parent itinerary such that the route in registered itinerary 1 passes through the route in registered itinerary 2. In this case, the merged itinerary may include that the user who is a participant of the parent itinerary joins and leaves the user who is a participant of the child itinerary at locations of the starting point and the final destination of the child itinerary. For example, in the route in the merged itinerary shown in FIG. 5, information in which the participant of registered itinerary 1 joins and leaves the participant of registered itinerary 2 at destination 1 and destination 5 that are the starting point and the final destination of registered itinerary 2, respectively, is added as a special note. When the two registered itineraries completely match (the degree of matching is 100%), the merged itinerary may simply merge the two registered itineraries into one registered itinerary.

The merged itinerary generated as described above can be expected to be convenient for both of the participants of the two registered itineraries when the degree of matching that gives the reproduction ratio is large. As a result, the server 100 can generate the merged itinerary in which both of the participants of the two registered itineraries are likely to consider to participate in the merged itinerary. When the two registered itineraries include information other than the route, the information other than the route in the merged itinerary can be, for example, a common part of the two registered itineraries. For example, when the date of registered itinerary 1 is within a period from August 10th to August 20th, and the date of registered itinerary 2 is within a period of from August 13th to August 25th, the date of the merged itinerary is set as August 13th to August 20th.

Therefore, the server 100 may be configured to give a predetermined condition to the two registered itineraries extracted when the degree of matching is calculated. For example, in a case of the registered itinerary shown in FIG. 2, the predetermined condition includes that the specified dates and times and the special notes do not contradict with each other, the dates are overlapped, the total number of participants of the two registered itineraries do not exceed the maximum number of participants, and the specified date and time and the expected number of days for each registered itinerary are satisfied when the two registered itineraries are merged. With this configuration, it is possible to avoid inconveniences for the participants in either one of the two registered itineraries having items are not related to the degree of matching, in the merged itinerary to be generated.

The server 100 inquires whether the merged itinerary thus generated is accepted or rejected to each of the participants of the two registered itineraries. Then, upon receiving the acceptance from the participants of each of the two registered itineraries, the server 100 sets the participants of each of the two registered itineraries as participants of the merged itinerary. Here, the server 100 may be configured to inquire whether the merged itinerary is accepted or rejected to all the participants of each of the two registered itineraries or only some of the participants of each of the two registered itineraries. In addition, the server 100 may be configured to manage the merged itinerary as a registered itinerary for recruiting more participants when the number of participants of the merged itinerary is less than the maximum number of participants or in response to requests from the participants of the merged itinerary. In this case, the merged itinerary may be configured to be extracted as one of the two registered itineraries for which the degree of matching is calculated.

As described above, the itinerary matching system 10 according to the present embodiment provides the itinerary matching function.

2. Configuration

Hereinafter, a configuration of the server 100 according to the present embodiment will be described with reference to the drawings.

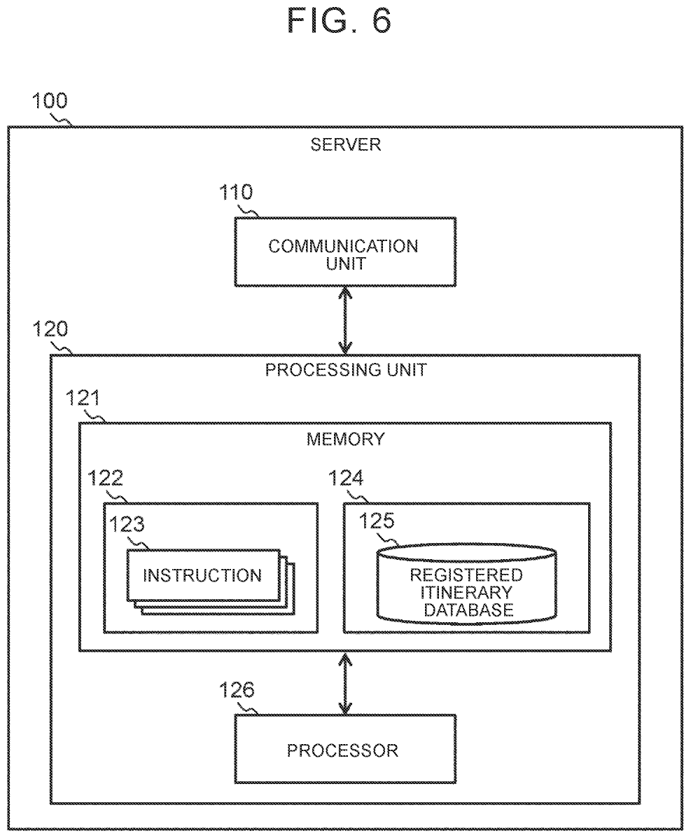

FIG. 6 is a block diagram showing a preferable example of the configuration of the server 100 according to the present embodiment. In FIG. 6, the server 100 includes a communication unit 110 and a processing unit 120. The communication unit 110 and the processing unit 120 are configured to be able to transmit information to each other. For example, the communication unit 110 and the processing unit 120 are electrically connected via a cable.

The communication unit 110 communicates with an external device of the server 100 to transmit and receive information. In particular, the communication unit 110 has a function for communicating with the user terminal (typically, communicate with the user terminal by connecting to the Internet). That is, the communication unit 110 allows the server 100 to communicate with the user terminal. In particular, the communication unit 110 receives the itinerary for which the registration is received from the user, transmits the list of the registered itinerary, receives the participation application for the registered itinerary, transmits the inquiry about the participation application, receives acceptance or rejection of the participation application, transmits the application result, and the like. Information received by the communication unit 110 through communication is transmitted to the processing unit 120.

The processing unit 120 executes a process related to the itinerary matching function. The processing unit 120 is a computer including a memory 121 and a processor 126.

The memory 121 stores an itinerary matching program 122 that is coupled to the processor 126 and causes the processor 126 to execute the process related to the itinerary matching function, and various data 124 necessary for executing the process. The memory 121 is an example of a storage medium. Here, the itinerary matching program 122 is composed of a plurality of instructions 123 executable by the processor 126. That is, the processor 126 operates according to the instructions 123 to implement the process related to the itinerary matching function.

Information acquired from the communication unit 110 is stored in the memory 121 as the data 124. In particular, the data 124 includes a registered itinerary database 125 in which the registered itineraries are made into a database. The construction of the registered itinerary database may be configured to be performed as a part of the process related to the itinerary matching function.

3. Process

Hereinafter, a process related to the merged itinerary, which is a characteristic process in the itinerary matching function provided by the itinerary matching system 10 according to the present embodiment, will be described with reference to the drawings.

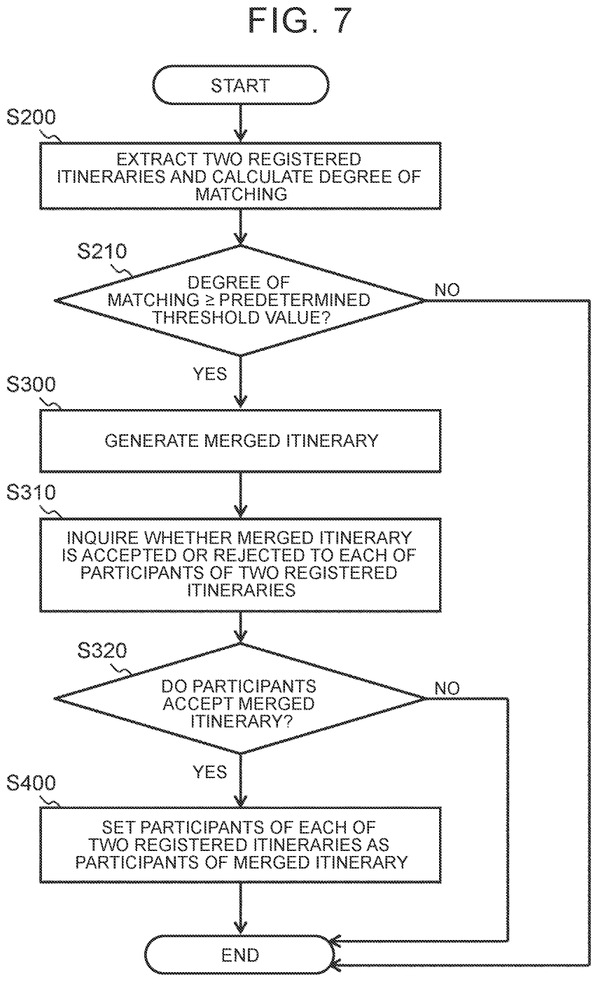

FIG. 7 is a flowchart showing an example of the process related to the merged itinerary. The process shown in FIG. 7 is typically executed by the server 100 at predetermined processing cycles. In the following description, it is assumed that the server 100 separately executes a process (first process) of receiving the registration of the itinerary from the user and a process of managing the registered itinerary.

In step S200 (second process), the server 100 extracts two registered itineraries from among the registered itineraries to be managed, and calculates the degree of matching between the extracted two registered itineraries.

When the degree of matching calculated in step S200 is less than the predetermined threshold value (step S210; No), the server 100 terminates the current process without generating the merged itinerary. On the other hand, when the degree of matching calculated in step S200 is equal to or greater than the predetermined threshold value (step S210; Yes), the process proceeds to step S300.

In step S300 (third process), the server 100 generates the merged itinerary for the two registered itineraries extracted in step S200. Then, the server 100 inquires whether the merged itinerary thus generated is accepted or rejected to the participants of each of the two registered itineraries (step S310).

When one of the participants of each of the two registered itineraries rejects the merged itinerary (step S320; No), the server 100 terminates the process without managing the merged itinerary. At this time, the server 100 may be configured to delete the generated merged itinerary. On the other hand, when the participants of each of the two registered itineraries accept the merged itinerary (step S320; Yes), the process proceeds to step S400.

In step S400 (fourth process), the server 100 sets the participants of each of the two registered itineraries as the participants of the merged itinerary. Here, the server 100 may be configured to manage the merged itinerary as the registered itinerary. After step S400, the process is terminated.

As described above, the server 100 executes the process related to the itinerary matching function. Further, as described above, the server 100 implements an itinerary matching method.

4. Effect

As described above, according to the present embodiment, the itinerary matching function for matching the participants of the registered itineraries is provided. Here, each of the registered itineraries may be a general itinerary in which the means of transportation are not limited and the route includes a plurality of destinations. In particular, according to the present embodiment, the degree of matching is calculated for two registered itineraries extracted from the registered itineraries, and the merged itinerary obtained by merging two registered itineraries in which the degree of matching exceeds the predetermined threshold value is generated Then, upon receiving the acceptance from the participants of each of the two registered itineraries, the participants of each of the two registered itineraries are set as the participants of the merged itinerary.

Thereby, it is possible to reduce the variations of the registered itineraries, and to reduce the annoyance to the user who searches for the registered itineraries. As a result, the feasibility of matching can be ensured. In addition, the feasibility of matching can be improved in that the participants of each of the two registered itineraries in which the degree of matching exceeds the predetermined threshold value can be given an opportunity to match each other.

The itinerary matching system 10 can also be configured to perform only matching of the participants according to the merged itinerary. In this case, the itinerary matching system 10 does not register the participants by the participation application, and each user registers the itinerary and waits for matching to be performed by generation of the merged itinerary.

Further, the itinerary matching system 10 according to the present embodiment can also be applied to a vehicle dispatch system configured to dispatch an autonomous driving vehicle according to the registered itinerary. In this case, the itinerary matching function is applied as a function of matching other passengers of the autonomous driving vehicle dispatched according to the registered itinerary. Thus, in this case, the vehicle dispatch system can provide a ridesharing function. In particular, by applying the itinerary matching system 10 according to the present embodiment, in the same manner as described above, the vehicle dispatch system can improve the feasibility of matching other passengers in the ridesharing function.

When the itinerary matching system 10 according to the present embodiment is applied, for example, the server 100 according to the present embodiment may be configured to be able to communicate with the autonomous driving vehicle via the communication unit 110. Further, the server 100 according to the present embodiment may be configured to transmit a vehicle dispatch plan according to the registered itinerary to the autonomous driving vehicle upon receiving acceptance from the participant or the representative of the registered itinerary. When the autonomous driving vehicle is autonomously driven according to the received vehicle dispatch plan, it is possible to realize the vehicle dispatch system that provides the ridesharing function.

What is claimed is:

1. An itinerary matching system for providing matching of participants of an itinerary, the itinerary matching system comprising one or more processors, wherein the one or more processors are configured to execute:
a first process of receiving registration of the itinerary;
a second process of extracting two registered itineraries from among a plurality of registered itineraries that have been registered and calculating a degree of matching between the two registered itineraries that have been extracted;
a third process of generating, upon receiving that the degree of matching exceeds a predetermined threshold value, a merged itinerary in which the two registered itineraries are merged; and
a fourth process of setting, upon receiving acceptance from a participant of each of the two registered itineraries, the participant of each of the two registered itineraries as a participant of the merged itinerary.

2. The itinerary matching system according to claim 1, wherein the one or more processors are configured to further execute:
a process of receiving participation application from a user for each of the registered itineraries;
a process of inquiring, upon receiving the participation application, whether the participation application is accepted or rejected to a participant of a target registered itinerary; and
a process of adding, upon receiving that the participant of the target registered itinerary accepts the participation application, the user to the participant of the target registered itinerary.

3. The itinerary matching system according to claim 1, wherein:
each of the registered itineraries includes information on a route from a starting point to one or more destinations; and
the second process includes calculating, as the degree of matching, a value obtained by dividing a length of an overlapping route in the two registered itineraries by a length of the route in a registered itinerary in which the length of the route is shorter among the two registered itineraries.

4. The itinerary matching system according to claim 3, wherein
the third process includes setting a route passing through the starting point and the one or more destinations in both of the two registered itineraries as a route in the merged itinerary.

5. An itinerary matching method for providing matching of participants of an itinerary by a computer, the itinerary matching method comprising:
receiving registration of the itinerary;
extracting two registered itineraries from among a plurality of registered itineraries that have been registered and calculating a degree of matching between the two registered itineraries that have been extracted;
generating, upon receiving that the degree of matching exceeds a predetermined threshold value, a merged itinerary in which the two registered itineraries are merged; and
setting, upon receiving acceptance from a participant of each of the two registered itineraries, the participant of each of the two registered itineraries as a participant of the merged itinerary.

6. A non-transitory storage medium storing an itinerary matching program that causes a computer to execute a process of providing matching of participants of an itinerary, the itinerary matching program being configured to cause the computer to execute:
a first process of receiving registration of the itinerary;
a second process of extracting two registered itineraries from among a plurality of registered itineraries that have been registered and calculating a degree of matching between the two registered itineraries that have been extracted;
a third process of generating, upon receiving that the degree of matching exceeds a predetermined threshold value, a merged itinerary in which the two registered itineraries are merged; and
a fourth process of setting, upon receiving acceptance from a participant of each of the two registered itineraries, the participant of each of the two registered itineraries as a participant of the merged itinerary.
